(19) United States
(12) Patent Application Publication
(10) Pub. No.: US 2012/0062470 A1
(43) Pub. Date: Mar. 15, 2012

(54) Power Management

(76) Inventor: Ray L. CHANG, Sunnyvale, CA (US)

(21) Appl. No.: 12/879,863

(22) Filed: Sep. 10, 2010

(51) Int. Cl. G06F 3/041

(52) U.S. Cl. 345/173

(57) ABSTRACT

A method for managing power usage of an electronic device including an accelerometer and a touch module is provided. The method includes placing the touch module in a lower power, lower functionality state if no activity is detected for a predetermined period of time; sensing a touch at the device by the accelerometer; and placing the touch module in a higher power, higher functionality state in response to the touch detected by the accelerometer.

### FIELD

This relates generally to power management of an electronic device, and more particularly, to reducing power consumption by turning off components such as the touch module of the device (or placing them in lower power modes) until a touch event is sensed by an accelerometer of the device.

### BACKGROUND

One important measurement of electronic devices, especially portable electronic devices, is how long their batteries can last. The usability of electronic devices is often measured, at least in part, based on how long their batteries last in various operation modes. Typically, users prefer devices that do not have to be charged frequently. Manufacturers of electronic devices are always in search of possible ways to improve battery life without making significant sacrifices in other aspects such as increasing the size and weight of the batteries.

In recent years, touch sensor panels, touch screens, and the like have become available as input devices. Touch screens, in particular, are becoming increasingly popular because of their ease and versatility of operation as well as their declining price. Touch screens can include a touch sensor panel, which can be a clear panel with a touch-sensitive surface, and a display device, such as an LCD panel, that can be positioned partially or fully behind the touch sensor panel or integrated with the touch sensor panel so that the touch-sensitive surface can cover at least a portion of the viewable area of the display device. Touch screens can allow a user to perform various functions by touching (or nearly touching) the touch sensor panel using one or more fingers, styli or other objects at a location often dictated by a user interface (UI) being displayed by the display device. In general, touch screens can recognize a touch event and the position of the touch event on the touch sensor panel, and a computing system can then interpret the touch event in accordance with the display appearing at the time of the touch event, and thereafter can perform one or more actions based on the touch event.

In some conventional devices, the touch sensor panel can be managed by a touch module which continuously scans the touch sensor panel to detect the presence of one or more touches on the panel. In some devices, this continuous scanning of the touch sensor panel can be performed as long as the display of the device is in use. As a result, the touch sensor panel and the touch module may consume a significant amount of power, thereby reducing the overall battery life. In some devices, even when the touch module/touch sensor panel is switched to a low-power mode that is still capable of detecting a touch, the power consumed by these components can still be relatively significant. Given that the touch sensor panel may not detect any touch for an extended period of time, e.g., when the user is reading an article in a Web browser on the display without scrolling or clicking any links, the power consumed by the touch sensor panel and touch module during this idle period can be wasteful.

### SUMMARY

This relates to reducing power consumption of an electronic device by turning off components such as the touch sensing component(s) of the device (or placing them in lower power modes) until a touch event is sensed by an accelerometer of the device. The accelerometers currently available can be relatively sensitive to even very minor movement of the host device. For example, a touch or even a light tap on a surface of an electronic device including an accelerometer can cause a slight movement of the device in the general direction of the touch, and that movement can be captured by the accelerometer. Embodiments of the present disclosure utilize this captured data as an indicator for turning on components such as the touch module and touch sensor panel of the device, or transitioning them to higher power operating modes. This can allow components such as the touch module and the touch sensor panel to be turned off completely or placed into lower power modes when no touch is being detected, and awakened to higher power states when the accelerometer indicates movement of the device as a result of a touch on the touch surface.

In one embodiment, first, the touch module can be switched off during an idling time when no touch is detected. While the touch module is turned off, the accelerometer can remain in a detection mode. When a user touches the surface of the touch sensor panel or other areas of the device, the accelerometer can capture the resulting movement of the device. Next, based on this data collected by the accelerometer, the touch module and other components can be turned back on or placed in a higher power, higher functionality state. Once operational, the touch sensor panel can collect additional data about the touch.

### BRIEF DESCRIPTION OF THE DRAWINGS

FIG. 1 illustrates the exemplary components of an electronic device including a touch sensor panel and an accelerometer according to embodiments of the disclosure.

FIG. 2 is a graph illustrating deviations detected by an accelerometer of an electronic device in the x, y, and z direction according to embodiments of the disclosure.

FIG. 3 is a flow chart illustrating exemplary steps of managing power consumption of a device including an accelerometer and a touch sensor panel, according to embodiments of the disclosure.

FIG. 4 illustrates an exemplary digital media player that can include a touch sensing system according to embodiments of the disclosure.

FIG. 5 illustrates an exemplary mobile telephone that can include a touch sensing system according to embodiments of the disclosure.

FIG. 6 illustrates an exemplary personal computer that can include a touch sensing system according to embodiments of the disclosure.

FIG. 7 illustrates an exemplary computing system that can incorporate device management according to embodiments of the disclosure.

### DETAILED DESCRIPTION

In the following description, reference is made to the accompanying drawings which form a part hereof, and in which it is shown by way of illustration specific embodiments which can be practiced. It is to be understood that other embodiments can be used and structural changes can be made without departing from the scope of the embodiments of this disclosure.

This relates to reducing power consumption of an electronic device by turning off components such as the touch sensing component(s) of the device (or placing them in lower power modes) until a touch event is sensed by an accelerometer of the device. An accelerometer is a device designed for measuring proper acceleration. Accelerometers have been widely incorporated in portable electronic devices such as cellular phones, tablet personal computers, and MP3 music players. When embedded in an electronic device, it can be used to detect different types of movement, such as tilting, changes in orientation, and vertical and horizontal movements of the device. The detected movements can then be translated to various functions depending on the application running on the device.

The accelerometers currently available can be relatively sensitive to even very minor movement of the host device. For example, a touch or even a light tap on a surface of an electronic device including an accelerometer can cause a slight movement of the device in the general direction of the touch, and that movement can be captured by the accelerometer. Embodiments of the present disclosure utilize this captured data as an indicator for turning on components such as the touch module and touch sensor panel of the device, or transitioning them to higher power operating modes. This can allow components such as the touch module and the touch sensor panel to be turned off completely or placed into lower power modes when no touch is being detected, and awakened to higher power states when the accelerometer indicates movement of the device as a result of a touch on the touch surface.

In comparison to components such as the touch module/touch sensor panel, the accelerometer typically consumes far less power. In other words, the power consumption of an accelerometer during a fixed period of time can be insignificant as compared to that of components such as the touch module/touch sensor panel. Thus, leaving the accelerometer on at all times may not significantly reduce the battery life of the device. In fact, certain applications running on the device may already require that the accelerometer be set to its detection mode for detecting movement of the device. In that case, embodiments of this invention may not require more power than what is already being consumed by the device. In contrast, the power savings achieved by turning off components such as the touch module/touch sensor panel or placing them in lower power states can make a noticeable difference in battery life. Test cases have shown that, in a portable device such as a tablet PC, the battery life can be extended for 15 minutes.

In the following paragraphs, various embodiments of the disclosure are discussed in detail. It should be understood that the touch module and touch sensor panel discussed in the embodiments described herein can be based on any types of touch technology including, but not limited to capacitive, resistive, surface acoustic wave, infrared, and optical image technologies. The touch sensor panel can be incorporated into a touch screen, touch pad, or any type of touch sensitive input device.

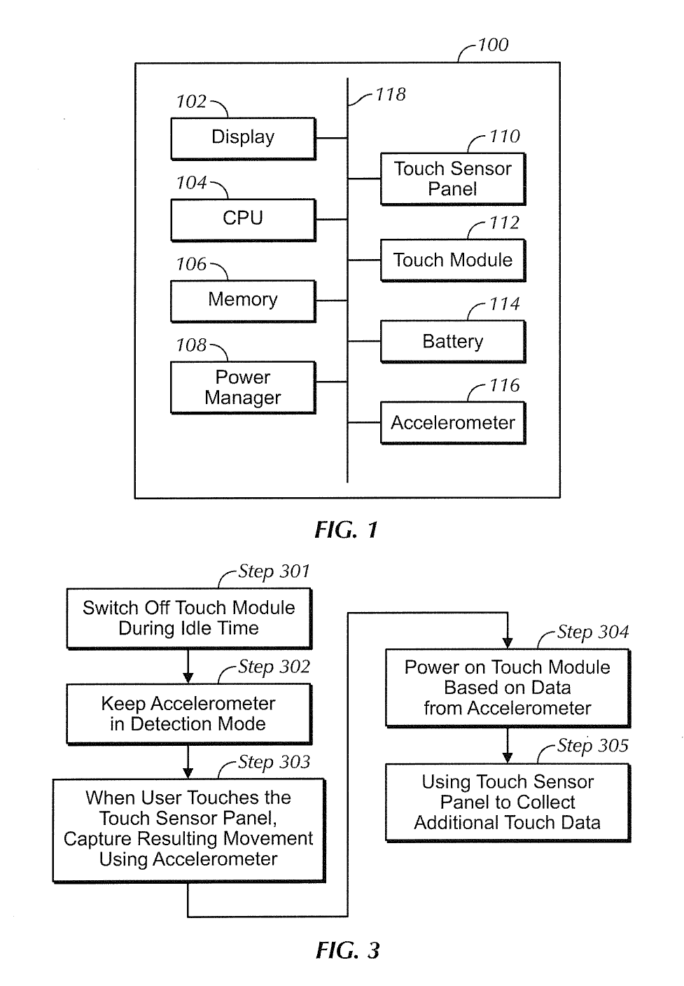

Embodiments of the invention can reduce power consumption by an electronic device which includes components such as a touch-based input device and an accelerometer. The electronic device can be a cellular phone, MP3 music player, tablet PC, etc. In one embodiment as illustrated in FIG. 1, the electronic device 100 includes a display 102, CPU 104, memory 106, touch sensor panel 110, touch module 112, battery 114, accelerometer 116, and a power manager 108, all in communication with each other via a bus 118 or any other means known in the art. The touch sensor panel 110 can provide a touch surface capable of detecting one or more touches or gestures by a finger, stylus, or any other objects. The touch module 112 can manage the scanning of the touch sensor panel 110 and capture touch data collected by the touch sensor panel 110. In some embodiments, the touch sensor panel 110 and the touch module 112 can be integrated as a single touch sensing component. The battery 114 can provide power to each of the components of the device including the touch sensor panel 110, touch module 112, and accelerometer 116. The power level of some or all of the components may be managed separately by the power manager 108. For example, the power manager 108 can shut down the touch sensor panel 110 while keeping the accelerometer 116 in full power mode.

As previously mentioned, in some conventional devices, the touch module and the touch sensor panel can be turned on whenever the display is on. In some devices, the touch module and touch sensor panel can remain powered on even when the display is in a low-power mode. In contrast, the power manager 108 of device 100 of FIG. 1 can shut down components such as the touch sensor panel 110 and the touch module 112 completely when no touch is detected by the panel 110 as determined by the accelerometer, or place them in lower power modes. In some embodiments, the powering-down (or transitioning to lower power states) of components such as the touch sensor panel 110 and the touch module 112 can take place after a predefined period of idling. For example, when a user is reading an electronic book on a tablet PC, the touch sensor panel 110 and the touch module 112 can be powered down in between the user flipping to the next page, while the user is reading but not touching the device and no accelerometer output indicative of a touch is being generated. As another example, when a user is watching a movie on the device, the touch sensor panel 110 and the touch module 112 can be powered down or placed in a lower power state when the user is simply watching the movie and no touch input is detected by the accelerometer. Other components of the device such as the display 102, CPU 104, memory 106, and accelerometer 116 can be managed separately by the power manager 108 to remain in full power mode. In other embodiments, a lack of accelerometer output indicative of a touch can even cause the display to be turned off or dimmed. For example, if a static image is being displayed (e.g., a photo), and no touch is detected for a certain period of time, the display can be dimmed or turned off under the assumption that no one may be viewing the display. In still other embodiments, other components such as proximity sensors or wireless transmitter circuitry may be powered down or placed in lower power modes. In either of these embodiments, the touch module can optionally be turned off as well. In still further embodiments, most or all nonessential components of the device can be placed in a lower power or powered down state (a deep sleep mode) such that the device maintains very little functionality. In any of these embodiments, an accelerometer output indicative of a touch on the touch sensor panel (or optionally anywhere on the device) can be used to wake up the device and place the device in higher power, higher functionality modes of operation. The preceding list of examples is intended to be illustrative, not exhaustive.

In any of the preceding embodiments, when the user touches the touch sensor panel 110 or other areas of the device, the device can rely on the accelerometer 116 to alert the power manager 108 to turn on the touch module 112, which can then restart scanning of the touch sensor panel 110. In some embodiments, the outputs of the accelerometer can be monitored and evaluated to distinguish between a touch on the touch sensor panel (which can cause the device to wake up and/or transition to higher power states) and a touch elsewhere on the device, which can cause no state changes in the device. In some embodiments, the x, y and z components of the movement detected by the accelerometer can be used to make this determination. The accelerometer 116 can be kept in a powered-on mode at all time or at least whenever the touch module and touch sensor panel are powered down.

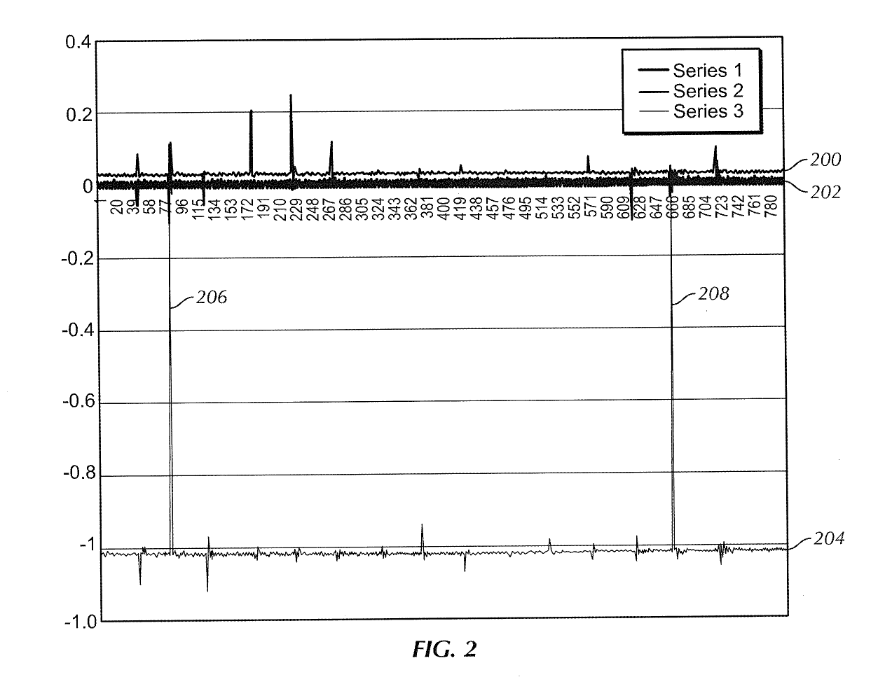

As mentioned earlier, a typical accelerometer can be used to detect a variety of movements of the host device in any of the x, y, and z directions. In the device 100 of FIG. 1, the accelerometer can be sensitive enough to sense a touch or even a light tap on the touch sensor panel 110 or other areas on the device because of the movement of the device 100 caused by the touch or tap, even if the device is laid on a solid surface. FIG. 2 is a diagram illustrating exemplary changes that can be detected by the accelerometer such as the one of FIG. 1 during a period of time when the user touches the touch sensor panel or other areas of the device. The three lines 200, 202, and 204 represent activities (i.e., deviations from a stationary state) of the device in the x, y, and z directions, respectively. In this embodiment, the x and y directions can be parallel to the surface of the touch sensor panel 110. The z direction can be perpendicular to the surface of the touch sensor panel 110. Accordingly, spikes shown in lines 200, 202 can represent movement in the x and y directions, respectively, which can be caused by a touch on the sides of the device as a user attempts to pick up the device from a table, for example. Line 204 can represent the change in the z direction, which can be caused by a touch on the touch sensor panel 110. Other touches can cause movement in any combination of x, y and z directions. In some embodiments, touches that primarily cause changes in the x and y directions can be interpreted as non-touch panel (e.g., side of device) touches that do not wake up the device.

As shown in FIG. 2, the normal value for z can be about −1 because of the effect of gravitational force on the accelerometer 116. The spikes 206 and 208 can reflect the occurrence of two separate touches on the touch sensor panel 110. Thus, even though the touch sensor panel 110 and the touch module 112 are in an off-mode, one or more touches on the touch sensor panel can still be sensed using the accelerometer 116. In response to detecting the z-direction spike using the accelerometer 116, the power manager 108 can power on the touch sensor panel and the touch module to capture more data on the touch such as the location and magnitude of the touch. Because it only takes a very short amount of time (e.g., tens to hundreds of microseconds) for the power manager 108 to turn on the touch sensor panel 110 and touch module 112 after being alerted by the accelerometer 116, the initial touch can still be captured by the touch sensor panel 110 after the panel and touch module are powered. In various embodiments, the sampling rate of the accelerometer 116 can be fine-tuned to produce optimal sensitivity for the purpose of sensing movement resulting from any touch on the touch sensor panel 110 or other areas of the device.

As mentioned above, touch sensor panel 110 and touch module 112 typically consumes much more power than the accelerometer 116. Therefore, turning off the touch sensor panel 110 and touch module 112 when they are not in use, and relying on the accelerometer 116 to serve as a sensor for sensing touch activity on the device, can make a significant impact on reducing power consumption by the host device 100 and, in turn, prolong battery life between charges.

FIG. 3 is a flow chart illustrating the exemplary steps of a method for managing power consumption of an electronic device including a touch sensor panel and an accelerometer. First, the touch module can be switched off during an idling time when no touch is detected. (Step 301) While the touch module is turned off, the accelerometer can remain in a detection mode. (Step 302) When a user touches the surface of the touch sensor panel or other areas of the device, the accelerometer can capture the resulting movement of the device. (Step 303) Next, based on this data collected by the accelerometer, the touch module and other components can be turned back on or placed in a higher power, higher functionality state. (Step 304) Once operational, the touch sensor panel can collect additional data about the touch. (Step 305)

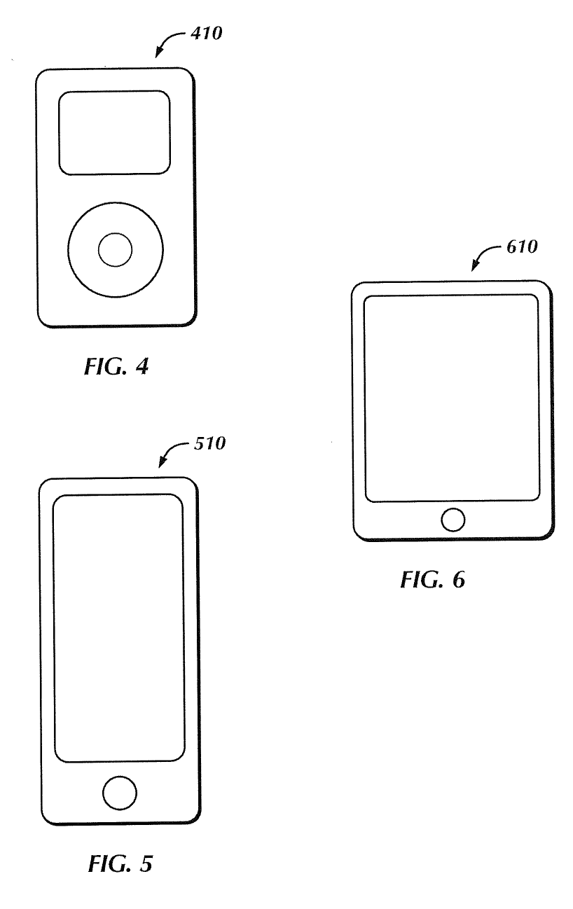

FIG. 4 illustrates exemplary digital media player 410 that can include a power management system according to embodiments of the disclosure.

FIG. 5 illustrates exemplary mobile telephone 510 that can include a power management system according to embodiments of the disclosure.

FIG. 6 illustrates an exemplary tablet PC 610 that can include a power management system according to embodiments of the disclosure.

The power manager 108 of the above-disclosed embodiments can be implemented in hardware, firmware, software, or a combination of any of the three. For example, the device management module can be implemented in firmware stored in memory 106 and executed by processor 104. The firmware can also be stored and/or transported within any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

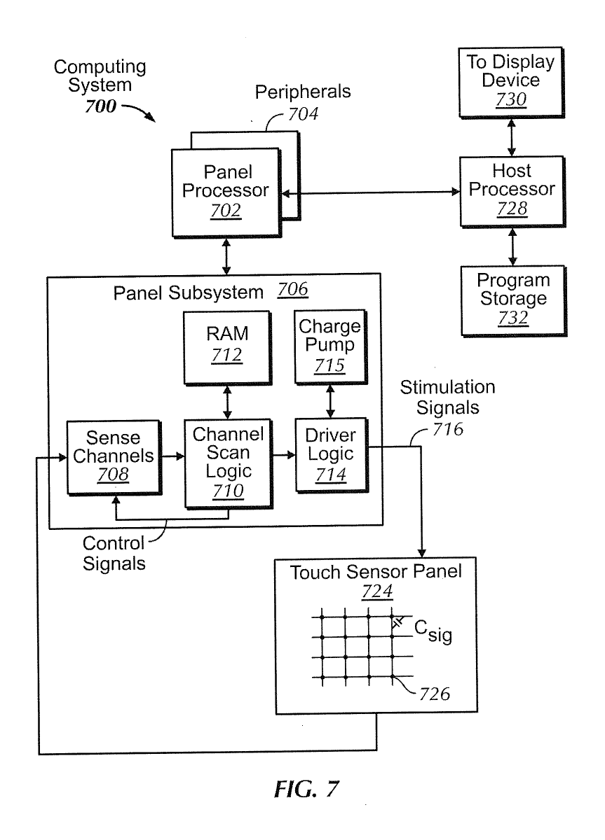

As described above, touch-based input devices such as touch screens and touch panels can be one type of device used for determining user presence and behavior. These touch-based input devices can use any existing touch technologies including, but not limited to, capacitive, resistive, in infrared and acoustic touch technologies. FIG. 7 illustrates exemplary computing system 700 according to embodiments of the disclosure. The system 700 can include one or more touch sensor panels according to the embodiments of the disclosure described above. Computing system 700 can include one or more panel processors 702 and peripherals 704, and panel subsystem 706. Peripherals 704 can include, but are not limited to, random access memory (RAM) or other types of memory or storage, watchdog timers and the like. Panel subsystem 706 can include, but is not limited to, one or more sense channels 708, channel scan logic 710 and driver logic 714. Channel scan logic 710 can access RAM 712, autonomously read data from the sense channels and provide control for the sense channels. In addition, channel scan logic 710 can control driver logic 714 to generate stimulation signals 716 at various frequencies and phases that can be selectively applied to drive lines of touch sensor panel 724. In some embodiments, panel subsystem 706, panel processor 702 and peripherals 704 can be integrated into a single application specific integrated circuit (ASIC).

Touch sensor panel 724 can include a capacitive sensing medium having a plurality of drive lines and a plurality of sense lines, although other sensing media can also be used. Either or both of the drive and sense lines can be coupled to a thin glass sheet according to embodiments of the disclosure. Each intersection of drive and sense lines can represent a capacitive sensing node and can be viewed as picture element (pixel) 726, which can be particularly useful when touch sensor panel 724 is viewed as capturing an “image” of touch. (In other words, after panel subsystem 706 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 724 can drive sense channel 708 (also referred to herein as an event detection and demodulation circuit) in panel subsystem 706.

Computing system 700 can also include host processor 728 for receiving outputs from panel processor 702 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 728 can also perform additional functions that may not be related to panel processing, and can be coupled to program storage 732 and display device 730 such as an LCD panel for providing a UI to a user of the device. Display device 730 together with touch sensor panel 724, when located partially or entirely under the touch sensor panel, can form touch screen 718.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method for managing power usage of an electronic device including an accelerometer and a touch module, comprising:
placing the touch module in a lower power, lower functionality state if no activity is detected for a predetermined period of time;
sensing a touch at the device by the accelerometer; and
placing the touch module in a higher power, higher functionality state in response to the touch detected by the accelerometer.

2. The method of claim 1, wherein the accelerometer remains powered-on as long as the touch module is turned off.

3. The method of claim 1, further comprising adjusting a sampling rate of the accelerometer to achieve optimal sensitivity for the accelerometer.

4. The method of claim 1, wherein the electronic device is one of a cellular phone, a MP3 music player, a tablet PC, and a computer with a touch sensing surface.

5. The method of claim 1, wherein the lower power, lower functionality state comprises a powered down state.

6. The method of claim 1, wherein sensing a touch on the device by the accelerometer comprises sensing movement in a direction perpendicular to a touch sensor panel.

7. The method of claim 1, further comprising maintaining the touch module in the lower power, lower functionality state when the touch is detected as being at a side of the device.

8. The method of claim 1, wherein the device further comprises a power manager for managing a power state of the touch module.

9. An electronic device, comprising:
an accelerometer;
a touch module; and
a power manager that manages the power supply to the touch module, the power manager connected to both the accelerometer and the touch module,
wherein the power manager places the touch module in a lower power, lower functionality state if no activity is detected for a predetermined period of time, and
wherein the power manager, in response to sensing a touch at the device by the accelerometer, placing the touch module in a higher power, higher functionality state in response to the touch detected by the accelerometer.

10. The electronic device of claim 9, wherein the accelerometer remains powered-on as long as the touch module is turned off.

11. The electronic device of claim 9, wherein a sampling rate of the accelerometer is adjusted to achieve optimal sensitivity for the accelerometer.

12. The electronic device of claim 9, wherein the electronic device is one or a cellular phone, a MP3 music player, a tablet PC, and a computer with a touch sensing surface.

13. The electronic device of claim 9, further comprising a capacitive touch sensor panel connected to the touch module.

14. The electronic device of claim 9, wherein the accelerometer senses the touch by detecting movement in a direction perpendicular to the touch sensor panel.

15. The electronic device of claim 9, further comprising a battery connected to the power manager for supplying power to the touch module and the accelerometer.

16. A computer-readable storage medium storing instructions for managing power consumption of an electronic device including an accelerometer and a touch module, the instructions when executed by a processor perform the method of:
placing the touch module in a lower power, lower functionality state if no activity is detected for a predetermined period of time;
sensing a touch at the device by the accelerometer; and
placing the touch module in a higher power, higher functionality state in response to the touch detected by the accelerometer.

17. The computer-readable storage medium of claim 16, wherein the accelerometer remains powered-on as long as the touch module is turned off.

18. The computer-readable storage medium of claim 16, wherein the method further comprises adjusting a sampling rate of the accelerometer to achieve optimal sensitivity for the accelerometer.

19. The computer-readable storage medium of claim 16, wherein the electronic device is one or a cellular phone, a MP3 music player, and a tablet PC.

20. A method for managing power usage of an electronic device including an accelerometer, comprising:
placing the device in a lower power, lower functionality state if no activity is detected for a predetermined period of time;
sensing a touch at the device by the accelerometer; and
placing the device in a higher power, higher functionality state in response to the touch detected by the accelerometer.

21. The method of claim 20, wherein the accelerometer remains powered-on as long as the device is in the lower power, lower functionality state.

22. The method of claim 20, further comprising adjusting a sampling rate of the accelerometer to achieve optimal sensitivity for the accelerometer.

23. The method of claim 20, wherein the electronic device is one of a cellular phone, a MP3 music player, and a tablet PC.

24. The method of claim 20, wherein the lower power, lower functionality state comprises a powered down state.

25. The method of claim 20, further comprising maintaining the device in the lower power, lower functionality state when the touch is detected as being at a side of the device.
